(19) United States
(12) Patent Application Publication
(10) Pub. No.: US 2014/0132567 A1
(43) Pub. Date: May 15, 2014

(54) MODIFYING A DIGITAL DOCUMENT RESPONSIVE TO USER GESTURES RELATIVE TO A PHYSICAL DOCUMENT

(71) Applicant: Peter Gomez, Stockholm (SE)

(72) Inventor: Peter Gomez, Stockholm (SE)

(73) Assignee: TELEFONAKTIEBOLAGET L M ERICSSON (PUBL), Stockholm (SE)

(21) Appl. No.: 14/127,696

(22) PCT Filed: Jul. 14, 2011
(86) PCT No.: PCT/IB2011/001641

§ 371 Date: Dec. 19, 2013

(51) Int. Cl. G06F 3/042; G06F 3/0488

(52) U.S. Cl. CPC G06F 3/0425; G06F 3/04883
USPC 345/175

(57) ABSTRACT

A user equipment node is disclosed that includes a camera device and a processor. The camera device outputs digital images. The processor identifies in at least one of the digital images at least one location of a user controlled object relative to a physical document. The processor also identifies at least one corresponding location within a digital document where a defined action is to be performed to modify the digital document. The digital document represents the physical document. The user equipment node may modify the digital document using the defined action at the at least one corresponding location to generate a modified digital document, or the user equipment node may communicate information to cause a network node to modify the digital document. Related network nodes are disclosed.

### TECHNICAL FIELD

The present invention relates to user equipment nodes and network nodes and, more particularly, to user interfaces for controlling modification of digital documents by user equipment nodes and/or network nodes.

### BACKGROUND

Conventional desktop and laptop computers, portable electronic devices, such as cellular telephones, personal digital assistants (PDAs), palmtop computers, and the like, have been provided with graphical user interfaces that allow users to edit documents at locations that are selected by moving a graphical object, such as a screen cursor. However, making selections within a document shown on a display device of a portable electronic device can be cumbersome and difficult. Early devices with graphical user interfaces typically used directional keys and a selection key that allowed users to highlight and select a desired location within a document. Such interfaces can be slow and cumbersome to use, as it may require many button presses to position the cursor in a document.

More recent devices have employed touch sensitive screens that permit a user to select a location within a document by scrolling the displayed document to a desired page and then pressing the screen at the viewed location. However, such devices have certain drawbacks in practice. For example, while the spatial resolution of a touch screen can be relatively high, users typically want to interact with a touch screen by touching it with a fingertip. Thus, the size of a user's fingertip limits the actual available resolution of the touchscreen, which means that it can be difficult to manipulate small text or other objects in a displayed document, particularly for users with large hands. Furthermore, when using a touchscreen, the user's finger can undesirably block all or part of the displayed document in the area being touched. System designers are faced with the task of designing interfaces that can be used by a large number of people, and thus may design interfaces with text or other objects larger than necessary for most people. Better touch resolution can be obtained by using a stylus instead of a touch screen. However, users may not want to have to use a separate instrument, such as a stylus, to interact with their device.

### SUMMARY

Various embodiments of the present invention are directed to providing an improved user interface that allows a user to modify an electronic document, which may reside on a user equipment node (UE) and/or on a network node using gestures (e.g., by a hand or other user controlled object) relative to a physical document. Because the user make gestures relative to the physical document in order to modify the electronic document, the user is not limited by whether or not the UE has a touchscreen and, moreover, by any limitations on the touch sensing resolution of the touchscreen.

One embodiment is directed to a UE that includes a camera device and a processor. The camera device outputs digital images. The processor identifies in at least one of the digital images at least one location of a user controlled object relative to a physical document. The processor also identifies at least one corresponding location within a digital document where a defined action is to be performed to modify the digital document. The digital document represents the physical document.

In some more detailed example embodiments, the UE may modify the digital document using the defined action at the at least one corresponding location to generate a modified digital document, or the user equipment node may communicate information to cause a network node to modify the digital document.

A user may, for example, define a location within a digital document that is to be edited by pointing to a corresponding location on a corresponding physical document. The UE can be positioned relative to the physical document to observe the user's pointing gesture relative to the physical document, and to identify the corresponding location within the digital document. The UE or a network node may perform the defined action to modify the digital document at the identified location to generate the modified digital document.

The processor may identify a location within the digital document where a text string is to be inserted in response to a location identified within a digital image where the user controlled object pointed to the physical document. The processor may receive the text string through a user input interface of the user equipment node, and insert the text string at the identified location within the digital document to generate the modified digital document.

The processor may identify a region between the user's fingers that is aligned between the camera and a corresponding region on the physical document, and/or may identify the region as a user moves an object to trace at least a portion of the region on the physical document. The processor may insert a user-selected digital image into the digital document at the identified region, and may control a size of the inserted digital image in response to a relative size of one or more features of the physical document.

Another embodiment is directed to a network node of a telecommunications system. The network node includes a network interface and a processor. The network interface communicates with a UE. The processor receives through the network interface at least one digital image from a camera device of the user equipment node, and identifies in the at least one digital image at least one location of a user controlled object relative to a physical document. The processor identifies at least one corresponding location within a digital document which represents the physical document in response to the at least one location of the user controlled object that is identified relative to the physical document. The processor performs a defined action to modify the at least one corresponding location within the digital document to generate a modified digital document.

Other UEs, network nodes, and/or methods according to embodiments of the invention will be or become apparent to one with skill in the art upon review of the following drawings and detailed description. It is intended that all such additional UEs, network nodes, and/or methods be included within this description, be within the scope of the present invention, and be protected by the accompanying claims. Moreover, it is intended that all embodiments disclosed herein can be implemented separately or combined in any way and/or combination.

### BRIEF DESCRIPTION OF THE DRAWINGS

The accompanying drawings, which are included to provide a further understanding of the disclosure and are incorporated in and constitute a part of this application, illustrate certain non-limiting embodiments of the invention. In the drawings:

FIG. 1 is a block diagram of a UE that is configured to operate in accordance with some embodiments of the present invention to identify location(s) within a digital document that are to be modified;

FIG. 2 illustrates example gestures that can be performed by a user relative to a physical document to cause the UE of FIG. 1 to identify locations within a corresponding digital document that are to be modified;

FIG. 3 illustrates a digital document that has been modified responsive to the gestures performed by the user relative to the physical document shown in FIG. 2;

FIG. 4 illustrates further example gestures that can be performed by a user relative to the physical document to cause the UE of FIG. 1 to identify locations within a corresponding digital document that are to be modified;

FIG. 5-7 illustrate flowcharts of operations and methods that may be performed by a UE to modify a digital document responsive to a location of a user controlled object relative to a corresponding physical document in accordance with some embodiments of the present invention;

FIG. 8 illustrates a telecommunications system that includes a UE, network node, and other elements that are configured to operate in accordance with some embodiments of the present invention;

FIG. 9-13 illustrate flowcharts of operations and methods that may be performed by a network node and a network node to modify a digital document responsive to a location of a user controlled object relative to a corresponding physical document in accordance with some embodiments of the present invention;

FIG. 14 is a block diagram of the UE of FIG. 1 that is configured according to some embodiments of the present invention; and

FIG. 15 is a block diagram of the network node of FIG. 8 that is configured according to some embodiments of the present invention.

### DETAILED DESCRIPTION

The following detailed description discloses various non-limiting example embodiments of the invention. The invention can be embodied in many different forms and is not to be construed as limited to the embodiments set forth herein.

Various embodiments of the present invention are directed to providing an improved user interface that allows a user to modify an electronic document, which may reside on a user equipment node (UE) and/or on a network node using gestures (e.g., by a hand or other user controlled object) relative to a physical document.

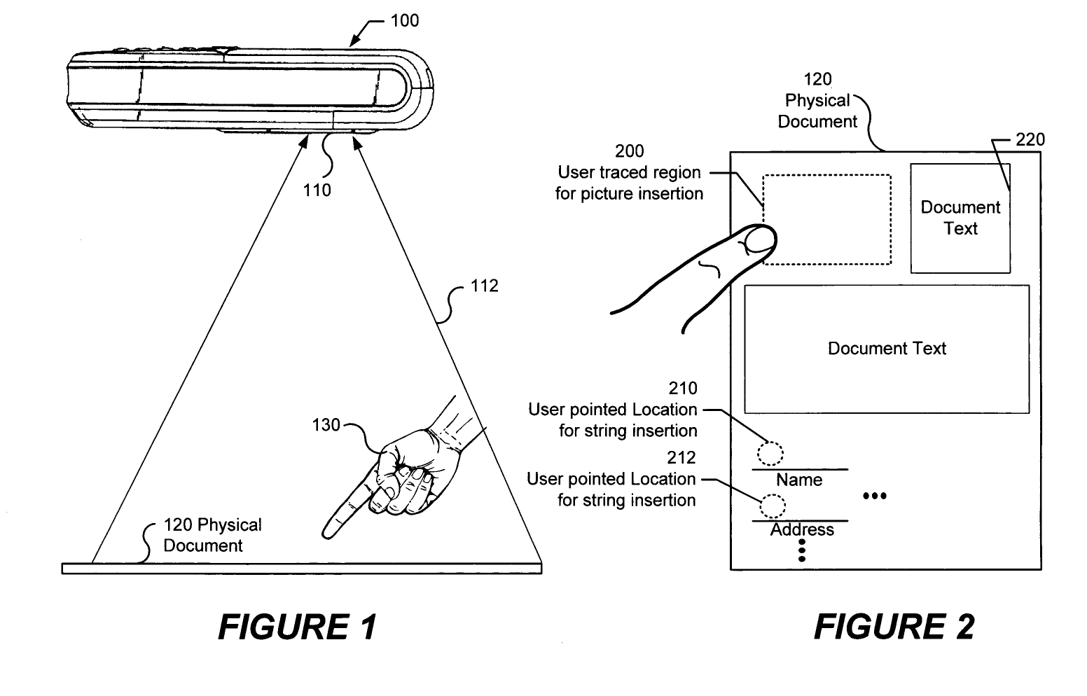

FIG. 1 is a block diagram of a UE 100 that is configured to operate in accordance with some embodiments of the present invention to identify location(s) within a digital document that are to be modified. The UE 100 includes a camera device (“camera”) 110 that is positioned to view a user controlled object 130, such as a finger of the illustrated hand, relative to a physical document 120. In operation, the UE 100 can be held a sufficient distance from a front surface of the physical document 120 so that a desired region of the physical document 120 and the user controlled object 130 are within a field of view 112 of the camera 110.

As will be explained in further detail below, the physical document 120 corresponds to a digital document (e.g., a Portable Document Format (PDF), Microsoft Word document, Tagged Image File Format (TIFF) document, Joint Photographic Experts Group (JPEG) document, or other digital document) that may reside in the UE 100 and/or in a network node. An improved user interface is provided that enables a user to point or other gesture toward the physical document 120 to provide an indication to the UE 100 of a location within the corresponding digital document where a defined action is to be performed.

The physical document 120 may be a template document with one or more locations where a user is to enter text, picture(s), or other information. A template document may, for example, include one or more blank regions within one or more lines of text where a user is to enter (e.g., type) text (e.g., alphanumeric or other characters/symbols) into the corresponding digital document, one or more blank lines where a user is to enter text into the corresponding digital document, and/or one or more regions where a user is to insert a digital image (e.g., picture and/or video frame) into the corresponding digital document.

However, the physical document 120 may be any type of document for which the UE 100 can identify a location of the user controlled object 130 relative to some reference defined on the physical document 120, such as relative to one or more reference edges (e.g., top, sides, bottom) of the physical document 120 and/or one or more reference graphical/textual objects that are printed/hand-written on the physical document, and which has a known relationship to a corresponding location(s) in the digital document. Accordingly, the physical document 120 may be a physical printout of the corresponding digital document, a more generalized physical template document, and/or a hand-drawn or otherwise rendered physical document that illustrates locations where a user is to enter information into the digital document.

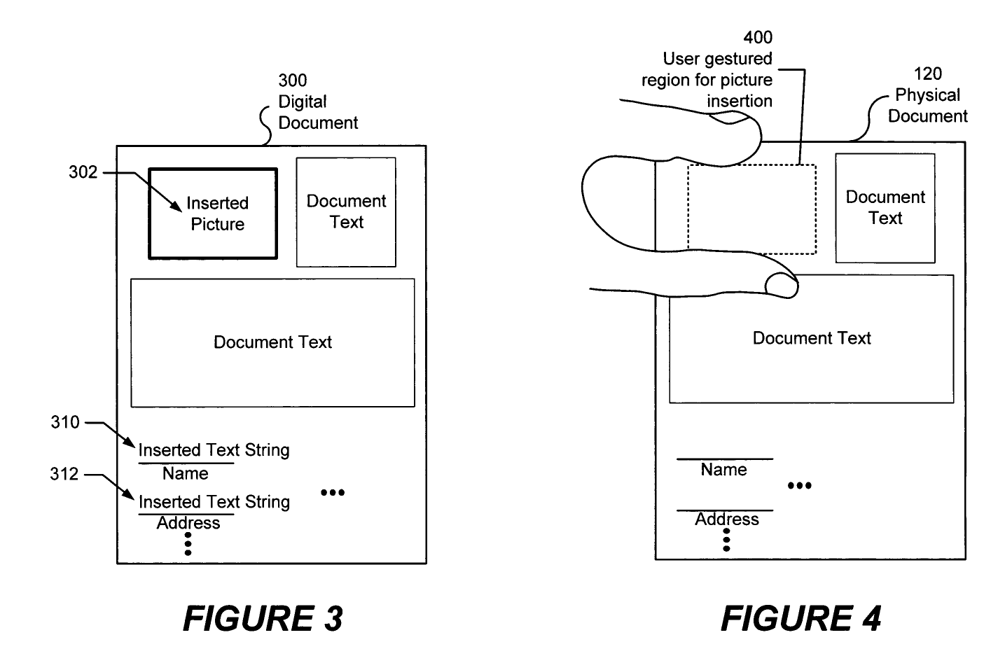

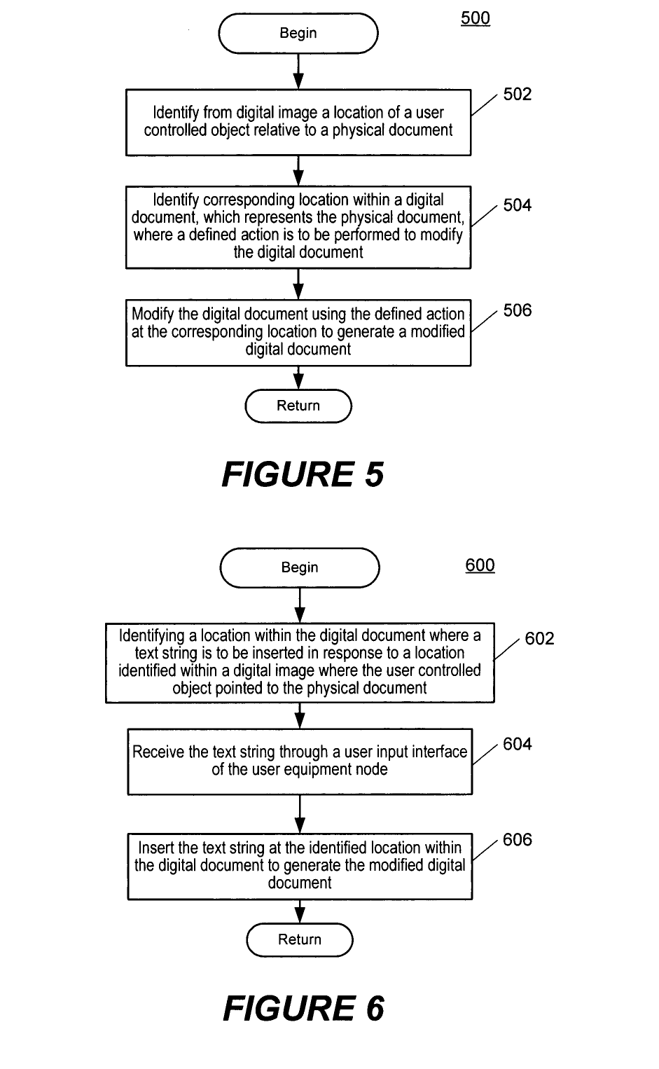

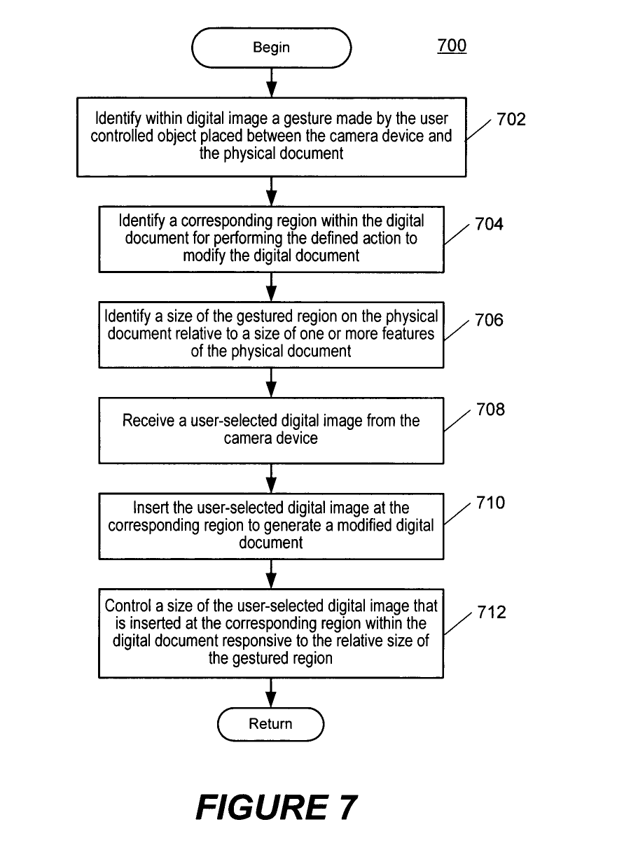

FIGS. 2 and 4 illustrate example gestures that can be performed by a user relative to an example physical document 120 to cause the UE 100 to identify locations within a corresponding digital document that are to be modified. FIG. 3 illustrates a digital document 300 that is modified responsive to various gestures that are performed by the user relative to the physical documents 120 shown in FIGS. 2 and/or 4. The example physical and digital documents 120 and 300 have been illustrated for ease of illustration and explanation only and are not limiting to the scope of the present disclosure.

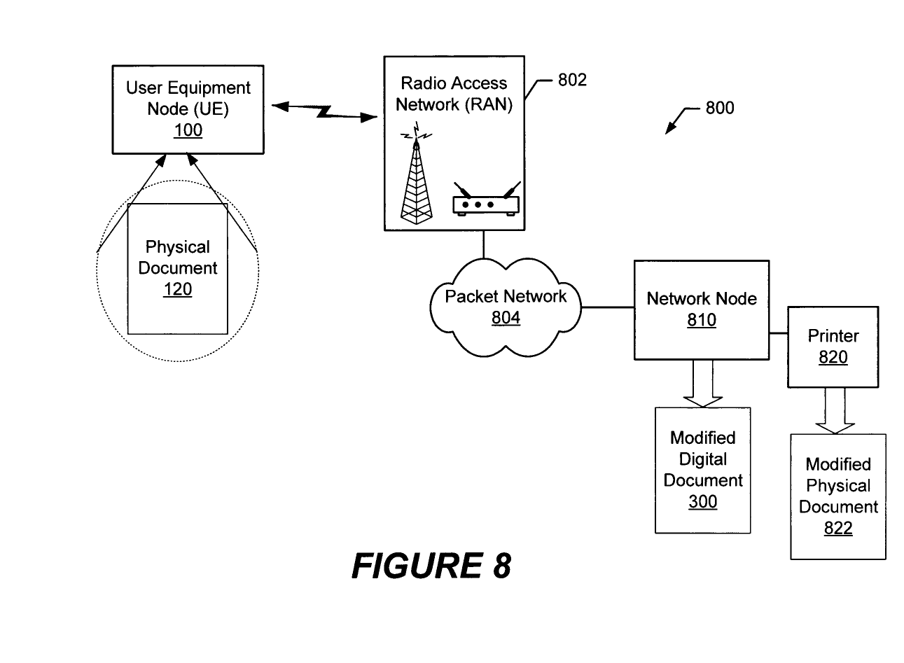

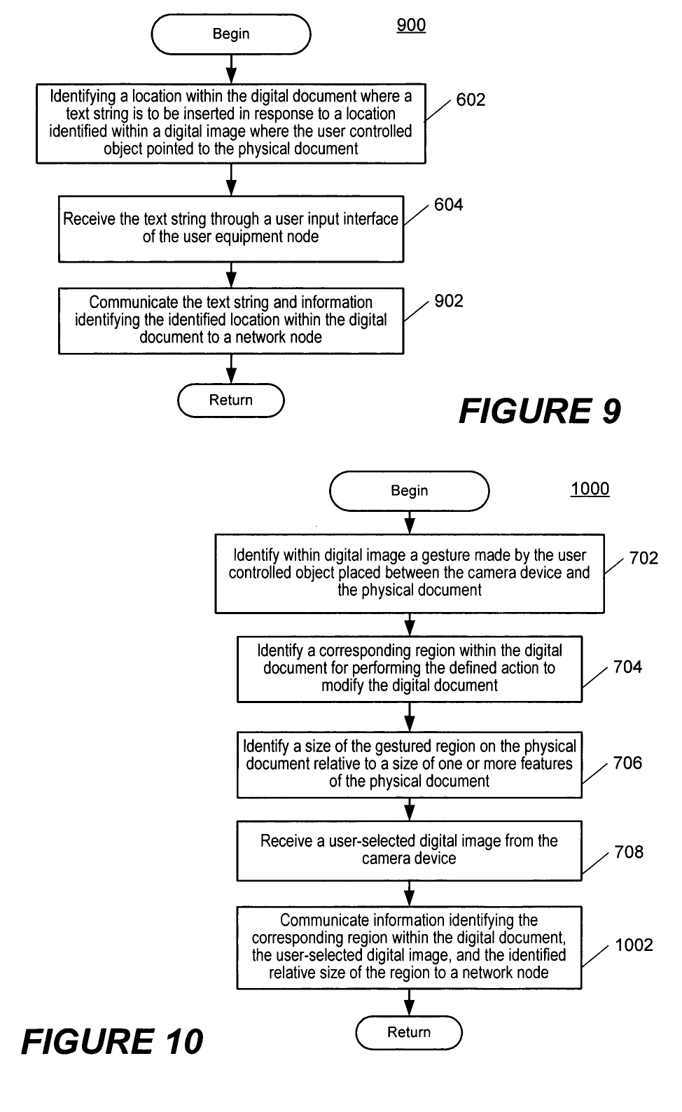

As will be explained below, either the UE 100 or a network node can operate to modify the digital document 300 after the UE 100 identifies at least one location of the user controlled object 130 relative to the physical document 120. Initially, operations and methods that can be performed by the UE 100 to modify the digital document are explained with reference to FIGS. 5-7. Various other operations and methods that can be performed by a network node to modify the digital document responsive to information communicated from the UE 100 are subsequently explained with reference to FIGS. 8-13.

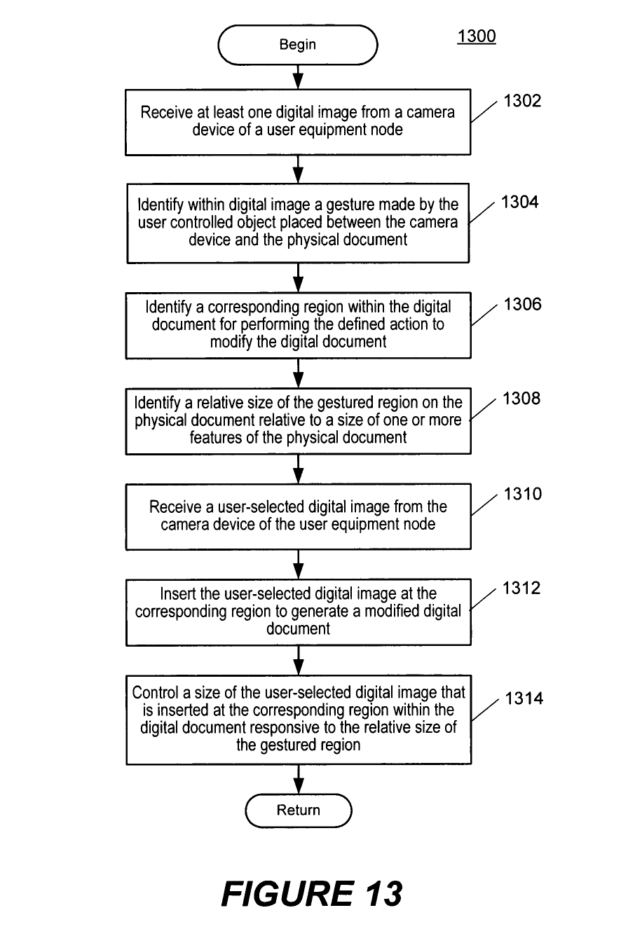

Referring to FIGS. 2 and 5, the UE 100, via operation of a processor 1402 which is described below with regard to FIG. 14, is configured to modify the digital document 300 responsive to one or more locations of the user controlled object 130 that are selected by a user relative to the physical document 120. The UE 100 identifies (block 502) in one or more digital images from the camera 110 at least one location of the user controlled object 130 relative to the physical document 120. The identification (block 502) may be carried out in response to a user selecting a defined activation trigger on the UE 100 (e.g., a physical hardware switch or software switch on a touch screen interface). The UE 100 identifies (block 504) at least one corresponding location within the digital document 300, which represents the physical document 120, where a defined action is to be performed to modify the digital document 300. The UE 100 modifies (block 506) the digital document 300 using the defined action at the corresponding location to generate a modified digital document.

In the particular example of FIG. 2, a user can control a finger or other object to point to locations 210 and 212 on the physical document 120 where text strings (e.g., alphanumeric or other symbols/characters) are to be inserted into the corresponding digital document 300. Associated operations and methods 600 that may be performed by the UE 100, via the processor 1402, are shown in FIG. 6. Referring to FIGS. 2 and 6, the UE 100 identifies (block 602) locations 310 and 312 within the digital document 300 where the text strings are to be inserted in response to identification by the UE 100 of locations 210 and 212 where the user controlled object 130 pointed to the physical document 120. As explained above, the identification (block 602) may be triggered by a user selecting a defined activation trigger on the UE 100. The UE 100 receives (block 604) one or more text strings through a user input interface (e.g., user input interface 1422 of the UE 100 shown in FIG. 14). The UE 100 inserts (block 606) the text string(s) at the identified locations 310 and 312 within the digital document 300 to generate the modified digital document.

A user may thereby, for example, point to a first location 210 on the physical document 120 and enter the user's name into the UE 100, and then point to a second location 212 on the physical document 120 and similarly enter the user's address into the UE 100. The UE 100 can respond by inserting the entered user's name and address into locations 310 and 312 within the digital document 300 that correspond to the first and second locations 210 and 212 where the user pointed on the physical document 120. The UE 100 may display the modified digital document 300 on a display device (e.g., display 1420 of FIG. 14).

By further operational example, the user can create a gesture relative to a region on the physical document 120 to identify a corresponding region in the digital document 300 that is to be modified. Exemplary operations and methods 700 that can be performed by the UE 100, via operation of the processor 1202 of FIG. 14, are shown in FIG. 7. Referring to FIG. 7, the UE 100 identifies (block 702) within at least one digital image from the camera 110 a gesture made by the user controlled object 130 placed between the camera 110 and the physical document 120. As explained above, the identification (block 708) may be triggered by a user selecting a defined activation trigger on the UE 100. The UE 100 identifies (block 704) a corresponding region 302 within the digital document 300 for performing the defined action to modify the digital document 300.

As shown in FIG. 2, the gesture may be created by the user tracing an outline of at least a portion of a region 200 where a digital image is to be inserted into a corresponding region 302 of the digital document 300, or where another defined action is to be performed to modify the digital document 300. To identify the gesture, the UE 100 may identify in a plurality of the digital images from the camera 110 a plurality of locations of the user controlled object that is moved relative to the physical document 120 to trace at least a portion of the region 200 on the physical document 120, and identify the corresponding region 302 within the digital document 300 for performing the defined action to modify the digital document in response to the plurality of locations identified within the digital images.

Alternatively or additionally, referring to FIG. 4, the gesture may be created by the user holding two or more fingers (or another object) spaced apart to define a region 400 on the physical document 120 as viewed between the spaced apart fingers/object which are aligned between the camera 110 and the region 400.

With further reference to FIG. 7, the UE 100 can receive (block 708) a user-selected digital image (e.g., digital photograph) from the camera 110 or another source (e.g., from memory within the UE 100 and/or from a network element), and can insert (block 710) the user-selected digital image at the corresponding region 302 identified within the digital document 300 to generate a modified digital document. The UE 100 may display the modified digital document on a display device (e.g., display 1420 of FIG. 14).

In some further embodiments, the UE 100 may identify (block 706) a size of the gestured region 200 and/or 400 relative to size of one or more features of the physical document 120. For example, the size of the gestured region 200 and/or 400 may be compared to a size of text that is printed on the physical document 120, a graphical object/icon that is printed on the physical document 120, physical edges (e.g., sides, top, bottom edges) and/or other references on the physical document 120 that are observed by the camera 110 and identifiable by the processor 1402 of the UE 100. The UE 100 may further control (block 712) a size of the user-selected digital image that is inserted at the corresponding region 302 responsive to the relative size of the gestured region 200 and/or 400 relative to the size of one or more features of the physical document 120 to generate the modified digital document. The UE 100 may scale the user-selected digital image using the relative sizes by knowing a scale factor that is to be applied and/or by determining a scale factor by comparing a size of the reference feature(s) in the physical document 120 to corresponding feature(s) in the digital document 300.

In a particular use example, a user may take a photograph using the camera and make a gesture relative to the physical document 120 to define the region 400 on the physical document 120 and, thereby, define the corresponding region 302 in the digital document 300 where the photograph is to be inserted. The size of the photograph that is inserted into the digital document 300 may be scaled responsive to a relative size of the region 400 compared to one or more features of the physical document 120 (e.g., compared to an adjacent block of text printed on the physical document 120).

In some other embodiments, the UE 100 communicates information to a network node, and the network node modifies the digital document. FIG. 8 illustrates a telecommunications system that includes the UE 100 and a network node 810 that are communicatively connected through a radio access network (RAN) 802 and a packet network 804.

The UE 100 may operate as described above to identify a location of a user controlled object relative to the physical document 120 (e.g., block 502 of FIG. 5) and to identify the corresponding location within the digital document 300 where a defined action is to be performed modify the digital document 300 (e.g., block 504 of FIG. 5). However, instead of the UE 100 performing the defined action, it may communicate information to the network node 810 to cause the network node 810 to perform the defined action at the identified location within the digital document 300 to generate a modified digital document.

The network 810 may locally store the modified digital document, may communicate the modified digital document to the UE 100 or another electronic device, and/or may print the modified digital document such as through a local or networked printer 820.

The packet network 804 may include a private network and/or public network (e.g., Internet). The RAN 802 may contain one or more cellular radio access technology systems that may include, but are not limited to, Global Standard for Mobile (GSM) communication, General Packet Radio Service (GPRS), enhanced data rates for GSM evolution (EDGE), DCS, PDC, PCS, code division multiple access (CDMA), wideband-CDMA, CDMA2000, Universal Mobile Telecommunications System (UMTS), and/or 3GPP LTE (3rd Generation Partnership Project Long Term Evolution). The RAN 802 may alternatively or additionally communicate with the UE 100 through a Wireless Local Area Network (i.e., IEEE 802.11) interface, a Bluetooth interface, and/or other radio frequency (RF) interface.

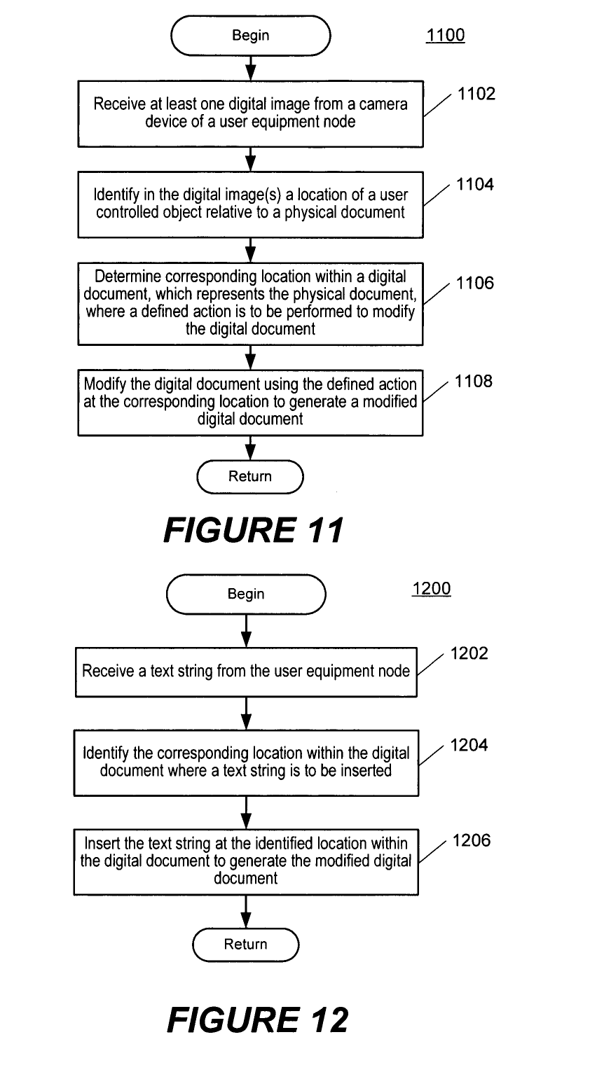

Referring to the operations and methods 900 of FIG. 9, the UE 100 may operate as described above for blocks 602 and 604 of FIG. 6 to identify a location within the digital document 300 where a text string is to be inserted in response to a location identified within the digital image where the user controlled object pointed to the physical document 120, and to receive the text string through a user input interface of the UE 100. The UE 100 may then communicate (block 902) the text string and information, which identifies the location identified within the digital document 300 where the text string is to be inserted, to the network node 810. The network node 810 can respond thereto by inserting the text string into the digital document 300 at the identified location to generate a modified digital document.

Referring to the operations and methods 1000 of FIG. 10, the UE 100 may operate as described above for blocks 702-708 of FIG. 7 to identify a gesture by the user, identify a corresponding region within the digital document 300 for performing the defined action, identify a size of the gestured region on the physical document 120 relative a size of one or features of the physical document 120, and receive a user-selected digital image. The UE 100 may then communicate (block 1002) information that identifies (e.g., contains) the user-selected digital image, the corresponding region within the digital document where the user-selected digital image is to be inserted, and the identified size, to the network node 810. The network node 810 can respond thereto by scaling the inserted user-selected digital image based on the identified size, and inserting the user-selected digital image into the digital document 300 at the identified region to generate a modified digital document.

In still some other embodiments, the network node 810 performs further operations to that have been described above as being performed by the UE 100. Referring to the operations and methods 1100 of FIG. 11, the network node 810 can be configured to receive (block 1102) at least one digital image (e.g., a picture of the user's hand pointing to a location on the physical document 120) from the camera 110 of the UE 100. The network node 810 can identify (block 1104) in the at least one digital image at least one location of a user controlled object relative to the physical document 120. The network node 810 can identify (block 1106) at least one corresponding location within the digital document 300 which represents the physical document 120 in response to the at least one location of the user controlled object that is identified relative to the physical document 120. The network node 810 can then perform a defined action to modify the at least one corresponding location within the digital document 300 to generate a modified digital document.

Further operations and methods 1200 that may be performed by the network node 810 are illustrated in FIG. 12. The network node 810 can receive (block 1202) a text string from the UE 100. The network node 810 can identify (block 1204) the corresponding location within the digital document 300 where the text string is to be inserted in response to a location identified within the at least one digital image where the user controlled object pointed. The network node 810 can then insert (block 1406) the text string at the corresponding location within the digital document 300 to generate the modified digital document.

Still further operations and methods 1300 that may be performed by the network node 810 are illustrated in FIG. 13. The network node 810 can be configured to receive (block 1302) at least one digital image from the camera 110 of the UE 100. The network node 810 may, for example, receive a picture of a user's hand forming a gesture that defines a region on the physical document 120, such as described above, and/or may receive a sequence of pictures that show a user's finger tracing at least a portion of a region on the physical document 120.

The network node 810 can identify (block 1304) within the received at least one digital image gesture made by the user controlled object placed between the camera 110 and the physical block 120. The network node 810 can then identify (block 1306) a corresponding region within the digital document 120 for performing the defined action to modify the digital document 120, and can identify (block 1308) a relative size of the gestured region on the physical document 120 relative to a size of one or more features of the physical document 120, such as described above with regard to FIG. 7. The network node 810 can receive (block 1310) a user-selected digital image from the UE 100, and can insert (block 1312) the user-selected digital image at the corresponding region in the digital document 300 to generate a modified digital document. The network node 810 may control (block 1314) a size of the user-selected digital image for insertion at the corresponding region within the digital block 300 responsive to the identified relative size of the gestured region.

### Example User Equipment Node and Network Node Configurations

FIG. 14 is a block diagram of the UE 100 of FIG. 1 that is configured according to some embodiments. The UE 100 includes a camera device 110, a transceiver 1406, a processor circuit 1402, and a memory device(s) 1410 containing functional modules 1412. When the UE 100 is configured to perform a defined action, such as described above with regard to FIGS. 5-7, the memory device 1410 may further include the digital document(s) 1414 that is to be modified by the UE 100, and the transceiver 1406 may be omitted. The UE 410 may further include a display 1420, a user input interface 1422, and a speaker 1424.

The transceiver 1406 (e.g., WCDMA, LTE, or other cellular transceiver, Bluetooth transceiver, WiFi transceiver, WiMax transceiver, etc.) is configured to communicate with the RAN 802 of the telecommunications system 800. The processor circuit 1402 may include one or more data processing circuits, such as a general purpose and/or special purpose processor (e.g., microprocessor and/or digital signal processor). The processor circuit 1402 is configured to execute computer program instructions from the functional modules 1412 of the memory device(s) 1410, described below as a computer readable medium, to perform at least some of the operations and methods of FIGS. 1-13 described herein as being performed by a UE.

The camera device 100 may be a CCD (charge-coupled device), CMOS (complementary MOS) or other type of image sensor, and can be configured to record still images and/or moving images as digital images that are suitable for processing by the processor 1402 as described above.

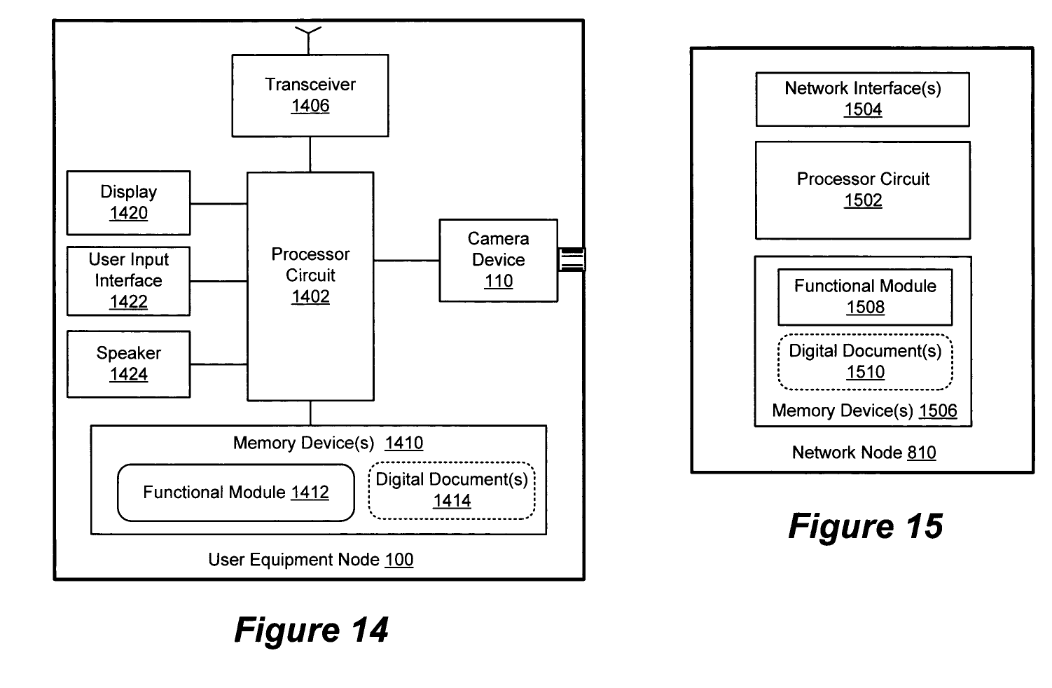

FIG. 15 is a block diagram of the network node 810 of FIG. 8 that is configured according to some embodiments. The network node 810 includes a network interface(s) 1504, a processor circuit 1502, and a memory device(s) 1506 containing functional modules 1508. The memory device(s) 1506 can further include a digital document(s) 1510 that the processor circuit 1502 is configured to modify in accordance with various operations and methods described above with regard to FIGS. 8-13. The network interface 1504 is configured to communicate with the UE 100 via the RAN 802 and the packet network 804.

The processor circuit 1502 may include one or more data processing circuits, such as a general purpose and/or special purpose processor (e.g., microprocessor and/or digital signal processor). The processor circuit 1502 is configured to execute computer program instructions from the functional modules 1508 of the memory device(s) 1506, described below as a computer readable medium, to perform at least some of the operations and methods of FIGS. 8-13 described herein as being performed by a network node.

### Further Definitions and Embodiments

In the above-description of various embodiments of the present invention, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When a node is referred to as being “connected”, “coupled”, “responsive”, or variants thereof to another node, it can be directly connected, coupled, or responsive to the other node or intervening nodes may be present. In contrast, when an node is referred to as being “directly connected”, “directly coupled”, “directly responsive”, or variants thereof to another node, there are no intervening nodes present. Like numbers refer to like nodes throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, nodes, steps, components or functions but does not preclude the presence or addition of one or more other features, integers, nodes, steps, components, functions or groups thereof Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

What is claimed is:

1. A user equipment node (100) comprising:
a camera device (110) that is configured to output digital images; and
a processor (1402) that is configured to identify (502) in at least one of the digital images at least one location of a user controlled object relative to a physical document, and to identify (504) at least one corresponding location within a digital document, which represents the physical document, where a defined action is to be performed to modify the digital document.

2. The user equipment node (100) of claim 1, wherein:
the processor (1402) is further configured to modify (506) the digital document using the defined action at the at least one corresponding location to generate a modified digital document.

3. The user equipment node (100) of claim 2, wherein the processor (1402) is further configured to modify (506) the digital document using the defined action at the at least one corresponding location to generate a modified digital document by:
identifying (602) a location within the digital document where a text string is to be inserted in response to a location identified within a physical image where the user controlled object pointed to the physical document;
receiving (604) the text string through a user input interface of the user equipment node (100); and
inserting (606) the text string at the identified location within the digital document to generate the modified digital document.

4. The user equipment node (100) of claim 1, wherein:
the processor (1402) is further configured to identify (702) within at least one digital image a gesture made by the user controlled object placed between the camera device (110) and the physical document and to respond by identifying (704) a corresponding region within the digital document for performing the defined action to modify the digital document.

5. The user equipment node (100) of claim 4, wherein:
the processor (1402) is further configured to identify (704) the corresponding region within the digital document responsive to a region between at least two fingers of a user that is aligned between the camera and a corresponding region on the physical document.

6. The user equipment node (100) of claim 4, wherein:
the processor (1402) is further configured to identify (702) in a plurality of the digital images a plurality of locations of the user controlled object that is moved relative to the physical document to trace at least a portion of a region on the physical document, and to identify (704) the corresponding region within the digital document for performing the defined action to modify the digital document in response to the plurality of locations identified within the digital images.

7. The user equipment node (100) of claim 4, wherein the processor (1402) is further configured to:
identify (704) the corresponding region within the digital document where a digital image is to be inserted in response to a region on the physical document that is indicated by the gesture made by the user;
receive (708) a user-selected digital image from the camera device (110); and
insert (710) the user-selected digital image at the corresponding region identified within the digital document to generate a modified digital document.

8. The user equipment node (100) of claim 7, wherein the processor (1402) is further configured to:
identify (706) a size of the region on the physical document relative to a size of one or more features of the physical document; and
control (712) a size of the user-selected digital image that is inserted at the corresponding region within the digital document to generate the modified digital document responsive to the size of the region on the physical document identified relative to the size of one or more features of the physical document.

9. The user equipment node (100) of claim 1, further comprising:
a transceiver (1406) that is configured to communicate with a network node (810),
wherein the processor (1402) is further configured to:
identify (602) a location within the digital document where a text string is to be inserted in response to a location identified within the digital image where the user controlled object pointed to the physical document;
receive (604) the text string through a user input interface of the user equipment node (100); and
communicate (902) the text string and information, which identifies the location identified within the digital document where the text string is to be inserted, through the transceiver (1406) to the network node (810) for insertion of the text string into the digital document at the identified location to generate a modified digital document.

10. The user equipment node (100) of claim 1, further comprising:
a transceiver (1406) that is configured to communicate with a network node (810),
wherein the processor (1402) is further configured to:
identify (702) within at least one digital image a gesture made by the user controlled object placed between the camera device (110) and the physical document that defines a corresponding region within the digital document for performing the defined action to modify the digital document;
communicate (1002) information, which identifies the corresponding region within the digital document, through the transceiver (1406) to the network node (810) to cause the defined action to be performed to modify the corresponding region within the digital document to generate a modified digital document.

11. The user equipment node (100) of claim 10, wherein the processor (1402) is further configured to:
identify (704) the corresponding region within the digital document responsive to a region between at least two fingers of a user that are placed between the camera device (110) and the physical document;
receive (708) a user-selected digital image from the camera device (110); and
communicate (1002) the user-selected digital image and information, which identifies the corresponding region within the digital document where the user-selected digital image is to be inserted, through the transceiver (1406) to the network node (810) to cause insertion of the user-selected digital image into the digital document at the corresponding region identified within the digital document to generate the modified digital document.

12. The user equipment node (100) of claim 10, wherein the processor (1402) is further configured to:
identify (702) in a plurality of the digital images a plurality of locations of the user controlled object that is moved relative to the physical document to trace at least a portion of a region on the physical document, and to identify the corresponding region within the digital document for performing the defined action to modify the digital document in response to the plurality of locations identified within the digital images;
receive (708) a user-selected digital image from the camera device (110); and
communicate (1002) the user-selected digital image and information, which identifies the corresponding region within the digital document, through the transceiver (1406) to the network node (810) to cause insertion of the user-selected digital image into the digital document at the corresponding region within the digital document to generate a modified digital document.

13. The user equipment node (100) of claim 10, wherein the processor (1402) is further configured to:
identify (706) a size of the region on the physical document relative to a size of one or more features of the physical document;
communicate (1002) information, which identifies the relative size of the shape, through the transceiver (1406) to the network node (810) to control a size of the user-selected digital image that is inserted into the digital document at the corresponding region within the digital document to generate the modified digital document.

14. A network node (810) of a telecommunications system, the network node (810) comprises:
a network interface (1504) that communications with a user equipment node (100); and
a processor (1502) that is configured to:
receive (1102) through the network interface (1504) at least one digital image from a camera device (110) of the user equipment node (100);
identify (1104) in the at least one digital image at least one location of a user controlled object relative to a physical document;
identify (1106) at least one corresponding location within a digital document which represents the physical document in response to the at least one location of the user controlled object that is identified relative to the physical document; and
perform a defined action to modify (1108) the at least one corresponding location within the digital document to generate a modified digital document.

15. The network node (810) of claim 14, wherein the processor (1502) is further configured to:
receive (1202) a text string from the user equipment node (100);
identify (1204) the corresponding location within the digital document where the text string is to be inserted in response to a location identified within the at least one digital image where the user controlled object pointed; and
insert (1206) the text string at the corresponding location within the digital document to generate the modified digital document.

16. The network node (810) of claim 14, wherein the processor (1502) is further configured to identify (1304) within at least one digital image a gesture made by the user controlled object placed between the camera device (110) and the physical document and to respond by determining a corresponding region within the digital document for performing the defined action to modify the digital document.

17. The network node (810) of claim 16, wherein the processor (1502) is further configured to identify (1306) the corresponding region within the digital document responsive to a region between at least two fingers of a user that is aligned between the camera and a corresponding region on the physical document.

18. The network node (810) of claim 16, wherein the processor (1502) is further configured to:
identify (1304) in a plurality of received digital images a plurality of locations of the user controlled object that is moved relative to the physical document to trace at least a portion of a region on the physical document; and
identify (1306) the corresponding region within the digital document for performing the defined action to modify the digital document in response to the plurality of locations identified within the digital images.

19. The network node (810) of claim 16, wherein the processor (1502) is further configured to:
identify (1306) the corresponding region within the digital document where a digital image is to be inserted in response to a shape of the gesture made by the user controlled object relative to the physical document;
receive a user-selected digital image from the camera device (110) of the user equipment node (100); and
insert (1312) the user-selected digital image at the corresponding region identified within the digital document to generate the modified digital document.

20. The network node (810) of claim 19, wherein the processor (1502) is further configured to:
identify (1308) a size of the region on the physical document relative to a size of one or more features of the physical document; and
control (1314) a size of the user-selected digital image that is inserted at the corresponding region identified within the digital document to generate the modified digital document responsive to the size of the region on the physical document identified relative to the size of one or more features of the physical document.
